(19) United States
(12) Patent Application Publication
(10) Pub. No.: US 2021/0157849 A1
(43) Pub. Date: May 27, 2021

(54) DETERMINING AN AUDIT LEVEL FOR DATA

(71) Applicant: International Business Machines Corporation, Armonk, NY (US)

(72) Inventors: Abhishek Jain, Baraut (IN); Joseph Dain, Vail, AZ (US); Nilesh Prabhakar Bhosale, Pune (IN); Sandeep Ramesh Patil, Pune (IN)

(21) Appl. No.: 16/695,651

(22) Filed: Nov. 26, 2019

(51) Int. Cl. G06F 16/908; G06F 16/909; G06F 16/9035; G06F 21/62; G06F 21/64

(52) U.S. Cl. CPC G06F 16/908; G06F 16/909; G06F 2221/2101; G06F 21/6218; G06F 21/64; G06F 16/9035

(57) ABSTRACT

A computer-implemented method according to one embodiment includes analyzing data to determine a sensitivity level for the data; assigning an audit level to the data, based on the sensitivity level; and performing auditing for the data, based on the audit level.

### BACKGROUND

The present invention relates to data security, and more particularly, this invention relates to dynamically determining audit levels for data based on data classification.

Data auditing, including the identification and logging of actions performed with respect to predetermined data, is an important component of data security. For example, data auditing may be performed in accordance with one or more compliance standards to ensure an integrity of stored data. However, data auditing is often performed on data for which auditing is not necessary, which results in wasted computing resources.

### BRIEF SUMMARY

A computer-implemented method according to one embodiment includes analyzing data to determine a sensitivity level for the data; assigning an audit level to the data, based on the sensitivity level; and performing auditing for the data, based on the audit level.

According to another embodiment, a computer program product for determining an audit level for data includes a computer readable storage medium having program instructions embodied therewith, where the computer readable storage medium is not a transitory signal per se, and where the program instructions are executable by a processor to cause the processor to perform a method including analyzing, by the processor, data to determine a sensitivity level for the data; assigning, by the processor, an audit level to the data, based on the sensitivity level; and performing, by the processor, auditing for the data, based on the audit level.

According to another embodiment, a system includes a processor; and logic integrated with the processor, executable by the processor, or integrated with and executable by the processor, where the logic is configured to analyze data to determine a sensitivity level for the data; assign an audit level to the data, based on the sensitivity level; and perform auditing for the data, based on the audit level.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 depicts a cloud computing environment in accordance with one embodiment of the present invention.

FIG. 2 depicts abstraction model layers in accordance with one embodiment of the present invention.

FIG. 3 depicts a cloud computing node in accordance with one embodiment of the present invention.

FIG. 4 illustrates a tiered data storage system in accordance with one embodiment of the present invention.

FIG. 5 illustrates a flowchart of a method for determining an audit level for data, in accordance with one embodiment of the present invention.

FIG. 6 illustrates a flowchart of a method for performing event-driven data auditing classification via database query, in accordance with one embodiment of the present invention.

FIG. 7 illustrates a flowchart of a method for performing event-driven data auditing classification via event consumer, in accordance with one embodiment of the present invention.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several embodiments of determining an audit level for data.

In one general embodiment, a computer-implemented method includes analyzing data to determine a sensitivity level for the data; assigning an audit level to the data, based on the sensitivity level; and performing auditing for the data, based on the audit level.

In another general embodiment, a computer program product for determining an audit level for data includes a computer readable storage medium having program instructions embodied therewith, where the computer readable storage medium is not a transitory signal per se, and where the program instructions are executable by a processor to cause the processor to perform a method including analyzing, by the processor, data to determine a sensitivity level for the data; assigning, by the processor, an audit level to the data, based on the sensitivity level; and performing, by the processor, auditing for the data, based on the audit level.

In another general embodiment, a system includes a processor; and logic integrated with the processor, executable by the processor, or integrated with and executable by the processor, where the logic is configured to analyze data to determine a sensitivity level for the data; assign an audit level to the data, based on the sensitivity level; and perform auditing for the data, based on the audit level.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

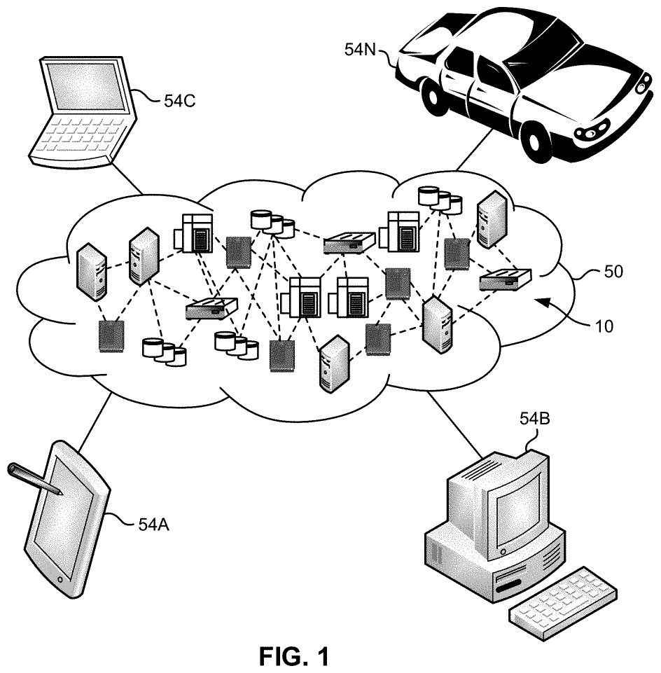

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

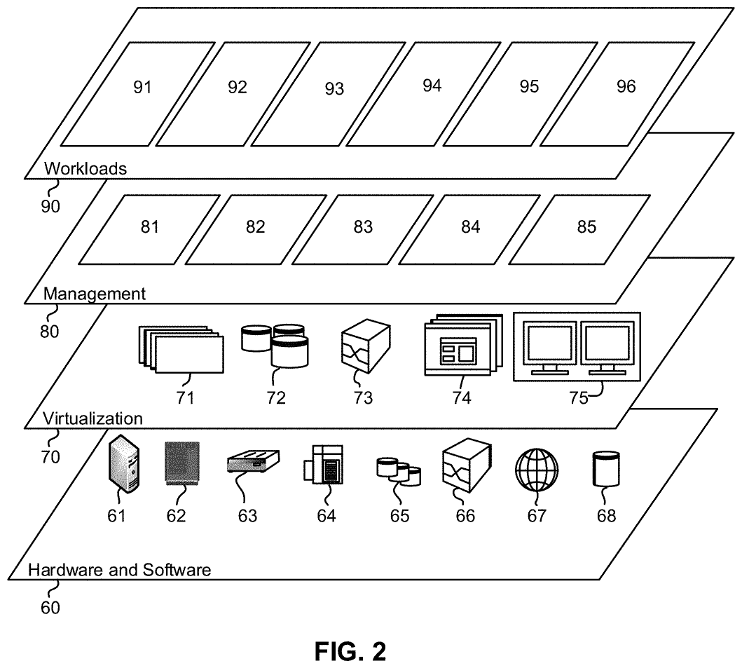

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and encryption key transmission 96.

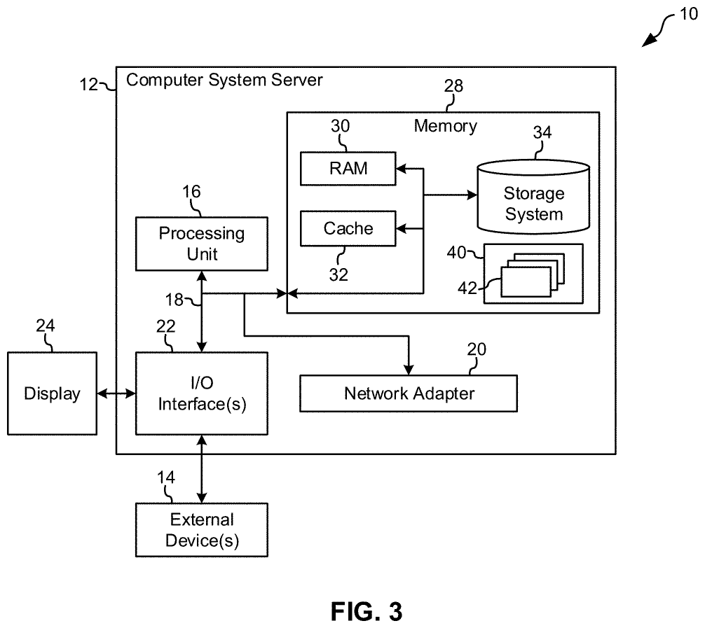

Referring now to FIG. 3, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 3, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

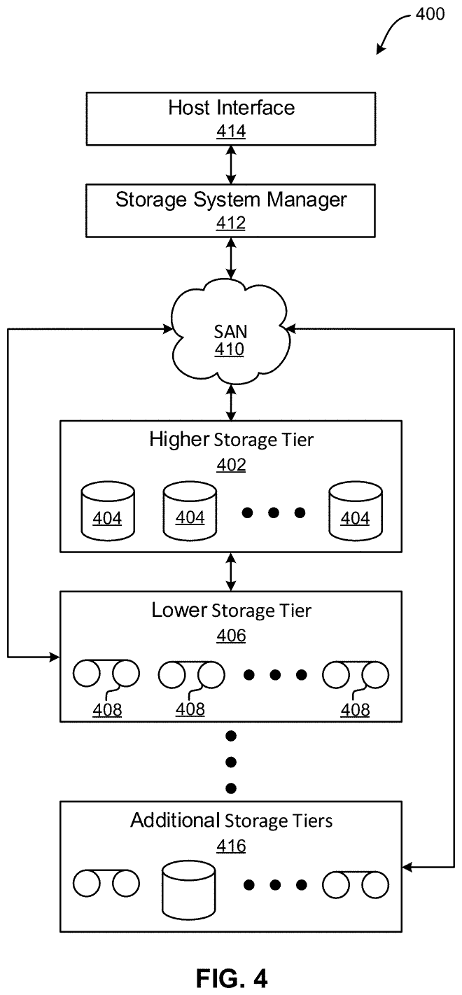

Now referring to FIG. 4, a storage system 400 is shown according to one embodiment. Note that some of the elements shown in FIG. 4 may be implemented as hardware and/or software, according to various embodiments. The storage system 400 may include a storage system manager 412 for communicating with a plurality of media on at least one higher storage tier 402 and at least one lower storage tier 406. The higher storage tier(s) 402 preferably may include one or more random access and/or direct access media 404, such as hard disks in hard disk drives (HDDs), nonvolatile memory (NVM), solid state memory in solid state drives (SSDs), flash memory, SSD arrays, flash memory arrays, etc., and/or others noted herein or known in the art. The lower storage tier(s) 406 may preferably include one or more lower performing storage media 408, including sequential access media such as magnetic tape in tape drives and/or optical media, slower accessing HDDs, slower accessing SSDs, etc., and/or others noted herein or known in the art. One or more additional storage tiers 416 may include any combination of storage memory media as desired by a designer of the system 400. Also, any of the higher storage tiers 402 and/or the lower storage tiers 406 may include some combination of storage devices and/or storage media.

The storage system manager 412 may communicate with the storage media 404, 408 on the higher storage tier(s) 402 and lower storage tier(s) 406 through a network 410, such as a storage area network (SAN), as shown in FIG. 4, or some other suitable network type. The storage system manager 412 may also communicate with one or more host systems (not shown) through a host interface 414, which may or may not be a part of the storage system manager 412. The storage system manager 412 and/or any other component of the storage system 400 may be implemented in hardware and/or software, and may make use of a processor (not shown) for executing commands of a type known in the art, such as a central processing unit (CPU), a field programmable gate array (FPGA), an application specific integrated circuit (ASIC), etc. Of course, any arrangement of a storage system may be used, as will be apparent to those of skill in the art upon reading the present description.

In more embodiments, the storage system 400 may include any number of data storage tiers, and may include the same or different storage memory media within each storage tier. For example, each data storage tier may include the same type of storage memory media, such as HDDs, SSDs, sequential access media (tape in tape drives, optical disk in optical disk drives, etc.), direct access media (CD-ROM, DVD-ROM, etc.), or any combination of media storage types. In one such configuration, a higher storage tier 402, may include a majority of SSD storage media for storing data in a higher performing storage environment, and remaining storage tiers, including lower storage tier 406 and additional storage tiers 416 may include any combination of SSDs, HDDs, tape drives, etc., for storing data in a lower performing storage environment. In this way, more frequently accessed data, data having a higher priority, data needing to be accessed more quickly, etc., may be stored to the higher storage tier 402, while data not having one of these attributes may be stored to the additional storage tiers 416, including lower storage tier 406. Of course, one of skill in the art, upon reading the present descriptions, may devise many other combinations of storage media types to implement into different storage schemes, according to the embodiments presented herein.

According to some embodiments, the storage system (such as 400) may include logic configured to receive a request to open a data set, logic configured to determine if the requested data set is stored to a lower storage tier 406 of a tiered data storage system 400 in multiple associated portions, logic configured to move each associated portion of the requested data set to a higher storage tier 402 of the tiered data storage system 400, and logic configured to assemble the requested data set on the higher storage tier 402 of the tiered data storage system 400 from the associated portions.

Of course, this logic may be implemented as a method on any device and/or system or as a computer program product, according to various embodiments.

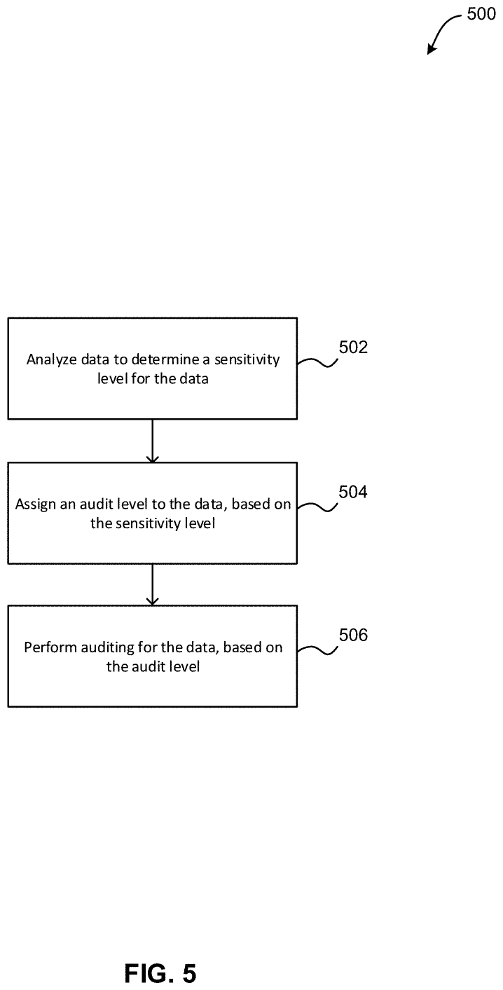

Now referring to FIG. 5, a flowchart of a method 500 is shown according to one embodiment. The method 500 may be performed in accordance with the present invention in any of the environments depicted in FIGS. 1-4, among others, in various embodiments. Of course, more or less operations than those specifically described in FIG. 5 may be included in method 500, as would be understood by one of skill in the art upon reading the present descriptions.

Each of the steps of the method 500 may be performed by any suitable component of the operating environment. For example, in various embodiments, the method 500 may be partially or entirely performed by one or more servers, computers, or some other device having one or more processors therein. The processor, e.g., processing circuit(s), chip(s), and/or module(s) implemented in hardware and/or software, and preferably having at least one hardware component may be utilized in any device to perform one or more steps of the method 500. Illustrative processors include, but are not limited to, a central processing unit (CPU), an application specific integrated circuit (ASIC), a field programmable gate array (FPGA), etc., combinations thereof, or any other suitable computing device known in the art.

As shown in FIG. 5, method 500 may initiate with operation 502, where data is analyzed to determine a sensitivity level for the data. In one embodiment, the data may include an instance of data such as a file, an object, etc. In another embodiment, the data may include a text document, an image, a movie, a spreadsheet, etc. In yet another embodiment, the data may be stored within a database (e.g., a single database, a distributed data storage system, etc.).

Additionally, in one embodiment, the data may be identified in response to parsing stored data within the database. In another embodiment, the data may be identified in response to receiving the data (e.g., receiving the data as an upload from a user or application, etc.). In still another embodiment, data may be identified within a data storage and/or processing system. For example, the system may include a cloud-based system.

Further, in one embodiment, analyzing the data may include performing deep data inspection on the data. In another embodiment, analyzing the data may include determining metadata associated with the data. For example, the metadata may describe one or more aspects of the data (e.g., one or more keywords found in the data, one or more instances of predetermined information (e.g., a phone number, social security number (SSN), etc.) found within the data, etc. In another example, the metadata may describe an owner of the data, a date and/or time of a creation of the data, a location of a creation of the data, etc.

Further still, in one embodiment, the metadata may be stored with the data and may be retrieved. In another embodiment, the metadata may be determined for the data by inspecting the data utilizing one or more techniques. For example, content analytics may be performed on the data to determine a description of the content of the data, where the description may be stored as metadata for the data.

In another example, sentiment analytics may be performed on the data to determine one or more sentiment values for the data, where the sentiment values may be stored as metadata for the data. In yet another example, natural language classification may be performed on the data to determine one or more classifier terms that are stored as metadata for the data. In still another example, a speech to text transformation may be performed on the data to determine one or more terms associated with the data that are stored as metadata for the data. In another example, visual recognition may be performed on the data to determine one or more terms associated with the data that are stored as metadata for the data.

Also, in one embodiment, analyzing the data may include comparing the metadata to one or more predetermined policies. In another embodiment, analyzing the data may include determining the sensitivity level for the data, based on the comparison. For example, one or more predetermined policies may indicate that a first predetermined sensitivity level is to be assigned to the data if the metadata associated with the data includes one or more predetermined elements determined to be sensitive and/or critical. For instance, if the metadata for the data includes sensitive data such as a password and/or social security number, the data may be assigned the first predetermined sensitivity level indicating that the data is sensitive.

In another example, one or more predetermined policies may indicate that a second predetermined sensitivity level is to be assigned to the data if the metadata associated with the data does not include one or more predetermined elements determined to be sensitive and/or critical. For instance, if the metadata for the data does not include sensitive data such as a password and/or social security number, the data may be assigned the second predetermined sensitivity level indicating that the data is not sensitive.

In addition, in one embodiment, the data may be assigned a predetermined sensitivity level in response to determining that the metadata for the data indicates that one or more predetermined types of information is contained within the data. For example, the data may be assigned a first level of sensitivity (indicating that the data is very sensitive) in response to determining that the metadata for the data includes a password. In another example, the data may be assigned a second level of sensitivity (indicating that the data is sensitive but not very sensitive) in response to determining that the metadata for the data includes a private phone number. In still another example, the data may be assigned a third level of sensitivity (indicating that the data is not sensitive) in response to determining that the metadata for the data does not include any sensitive information.

Furthermore, in one embodiment, the sensitivity level may be binary (e.g., sensitive or not sensitive). In another embodiment, the sensitivity level may be based on a scale (e.g., from one (very sensitive) to five (not sensitive)).

Further still, method 500 may proceed with operation 504, where an audit level is assigned to the data, based on the sensitivity level. In one embodiment, the audit level may be assigned to the data by applying the sensitivity level to one or more predetermined policies.

For example, a first audit level (e.g., indicating that stringent auditing is to be performed for the data) may be assigned to the data in response to determining that the data has a first sensitivity level (e.g., indicating that the data is very sensitive). In another example, a second audit level (e.g., indicating that less stringent auditing is to be performed for the data) may be assigned to the data in response to determining that the data has a second sensitivity level (e.g., indicating that the data is less sensitive than a first sensitivity level). In yet another example, an nth audit level (e.g., indicating that no auditing is to be performed for the data) may be assigned to the data in response to determining that the data has an nth sensitivity level (e.g., indicating that the data is not sensitive).

Also, in one embodiment, the audit level may be assigned to the data by analyzing the sensitivity level for the data in association with one or more environmental factors (e.g., a current location of the data, etc.), one or more types of the data, etc.

Additionally, method 500 may proceed with operation 506, where auditing is performed for the data, based on the audit level. In one embodiment, the audit level may indicate one or more types of auditing to be performed for the data, one or more locations where the auditing may be performed, one or more entities to perform the auditing, one or more locations where auditing data is to be stored, etc.

Further, in one embodiment, performing the auditing for the data may include monitoring access to the data within a system (e.g., the system in which the data is identified, etc.). For example, performing the auditing for the data may include identifying and logging changes made to the data (e.g., modification, deletion, etc. of both the data and attributes of the data), as well as entities performing the changes. In another example, performing the auditing for the data may include identifying and logging read requests made for the data, as well as entities sending the requests.

Further still, in one example, performing the auditing for the data may include identifying and logging access authorization requests made for the data, as well as entities sending the requests. In another example, performing the auditing for the data may include identifying and logging movement and/or migration of the data, as well as entities performing the movement and/or migration, and source and destination locations for the movement and/or migration.

Also, in one embodiment, performing the auditing for the data may include recording results of monitoring the access to the data. For example, identified changes to the data, read requests for the data, authorization requests for the data, and/or movement/migration of the data may be logged and stored in a predetermined location. In another example, the predetermined location may be indicated for the audit level within a policy.

In addition, in one embodiment, the audit level may indicate one or more locations within the system where the auditing is to be performed for the data. For example, the system may include one or more of cloud storage, virtual storage, distributed storage, etc. In another example, the audit level may indicate one or more of these locations where auditing is to be performed.

Furthermore, in one embodiment, an amount and/or location of the monitoring, as well as a location for recording results of the monitoring, may be indicated for the audit level within a policy. For example, if the data has a first audit level (e.g., indicating that stringent auditing is to be performed for the data), identified changes to the data, read requests for the data, authorization requests for the data, and/or movement/migration of the data may be logged and stored in a predetermined location.

In another example, if the data has a second audit level (e.g., indicating that less stringent auditing is to be performed for the data), a subset of the monitoring performed for the first audit level may be performed for the data. For instance, only identified changes to the data, and movement/migration of the data may be logged and stored in a predetermined location. In yet another example, if the data has an nth audit level (e.g., indicating that no auditing is to be performed for the data), no auditing may be performed for the data within the system.

Further still, in one embodiment, a second analysis may be performed on the data after the audit level has been assigned to the data. For example, the second analysis may be performed for the data after a predetermined amount of time has passed since the audit level was assigned to the data. In another embodiment, it may be determined whether the data has changed since the audit level was initially assigned to the data, and the second analysis may be performed only if the data has been changed since the audit level was initially assigned to the data. In another embodiment, a second sensitivity level may be determined for the data, based on the second analysis. For example, the second sensitivity level may be different from the initial sensitivity level determined for the data.

Also, in one embodiment, a second audit level may be assigned to the data, based on the second sensitivity level. For example, the second audit level may be different from the initial audit level assigned to the data. In another example, the data may have become more or less sensitive since the initial audit level was assigned.

Additionally, in one embodiment, auditing may be adjusted for the data, based on the second audit level. For example, an amount and/or location of the monitoring, as well as a location for recording results of the monitoring, may be adjusted to account for the second audit level. In another example, the amount and/or location of the monitoring, as well as a location for recording results of the monitoring, may be indicated for the second audit level within a policy.

As a result, data auditing may be dynamically adjusted over time as the sensitivity of the data changes within the system over time.

In this way, an amount and type of auditing may be dynamically identified and adjusted for data within a system over time. This may optimize an amount of auditing that is performed within the system, and may reduce an amount of auditing that is unnecessarily performed on data within the system, which may improve a performance of one or more system resources (e.g., processing, bandwidth, storage, etc.) utilized during such auditing.

Dynamic Tuning of Audit Level Based on Changing Data Classification

File Auditing

Many compliance standards revolve around a protected data set (e.g., health records, credit card details, personal information, etc.) and provide guidance around both optional and mandatory controls used to ensure proper access to, and usage of, that data. Some examples of compliance mandates with easily applicable standards are the Payment Card Industry Data Security Standard (PCI DSS) v3.0 and the European Union's forthcoming General Data Protection Regulation (GDPR).

File auditing capabilities enable logging of all access or changes to files/folders including data and permissions (which is easily accessible to be reviewed, filtered, searched, etc.), alerting using notifications based on matching criteria for actions and reporting.

File Auditing Levels

Multiple file auditing levels, may exist, including, for example:

1. Authorization Level Auditing: File Auditing based on whether a user/group has the right access permission based on the ACL on the file and auditing for operation (e.g., chmod, chown etc. on file/directory, etc.)

2. Data Level Auditing: File level auditing where file/object's data read/write/append/delete operations will be audited.

3. Attribute or Metadata Level Auditing: File/object level attribute or metadata change/append/delete operation will be audited.

4. Data Movement Level Auditing: Original file/object will be audited based on data movement, replication or copy operations to where is data being moved.

Data Insights

We are experiencing an exponential data explosion in today's world. Most data is unstructured in nature, and is growing rapidly. Also, the data is spread across multiple storage islands in a typical enterprise deployment which produces a data junkyard. There will not be any basic organization to it unless data has been processed. On the other hand, data is getting generated at such a rapid speed that it becomes practically challenging to classify the sensitive/critical data across these storage islands where large quantities of data are generated every day, and organizations fail to identify which data needs more protection and which data needs less. This adds inefficiencies to the system which ends up spending unnecessary space on more secured data subsystems for non-sensitive data.

In response, modern metadata management software provides data insight for large-scale unstructured storage. The software easily connects to cloud storage other storage structures to rapidly ingest, consolidate, and index metadata for many files and objects. The software provides a rich metadata layer that enables storage administrators, data stewards, and data scientists to efficiently manage, classify, and gain insights from massive amounts of unstructured data. It improves storage economics, helps mitigate risk, and accelerates large-scale analytics to create a competitive advantage and improve a speed of critical research.

Some challenges that the above implementation solves includes:
Pinpointing and activating relevant data for large-scale analytics.
Need for fine-grained visibility to map data to business priorities.
Removing redundant, trivial, and obsolete data.
Identifying and classifying sensitive data.

Auditing is always a resource intensive operation and may impact an overall performance of the system. Moreover, auditing everything and anything results in more noise than value. So, it is vital to recognize what data needs to be audited and what level of auditing should be enabled for that data. Moreover, information including a type of data and a level of auditing associated with that data should not be static. Importance and classification of data evolves and varies from time to time. Hence it is vital that as the classification of data changes dynamically the auditing of that data should also be appropriately changed.

In one embodiment, classification is performed at a massive scale of data silos to find candidates (e.g., files/objects) based on data sensitivity, which requires a different auditing level, by leveraging deep data inspection techniques such as content analytics, sentiment analytics, contextual views based on natural language classification as well as APIs such as speech to text transformation, visual recognition, etc. These techniques help in capturing metadata information about the data on a storage subsystem.

For example, metadata is first scanned from a storage subsystem to understand which of the files/objects contain sensitive or critical information based on the policies defined by storage administrators and/or system defined default policies. Policies trigger deep data inspection leveraging data inspection techniques that extract facets from the candidate (file/object) data, where the facets are indexed. The system then can query the indexed facets to identify candidate (e.g., sensitive and/or critical) documents based on facets available and calculate the sensitivity/criticality level to define the audit level for better reporting and anomaly detection analysis. This is repeated at regular intervals to ensure that the sensitivity/criticality level of the data is always current based on changing rules of classification of data as well as changing data content. The above results in dynamic setting that adjusts the level of auditing to the ever-changing classification of data to ensure that the data is auditing at the right levels required for compliance, security, etc.

In one embodiment, continual scanning of file and object data is performed in real time and such data is tagged to indicate a specific sensitivity level (e.g., from Level 1-Basic to Level 5-Stringent) and based on the data credibility score, define the auditing levels.

In another embodiment, continual scanning is performed on data to identify the sensitivity status of all stored data, which is then categorizes for different auditing levels.

In yet another embodiment, it is ensured that the files and objects that are tagged with a sensitivity level are categorized for different auditing levels such that Level 5 data is being audited with all required information while Level 1 data can be audited at a basic level with limited information.

In one embodiment, classification is performed at a massive scale of data to find a candidate (e.g., file/object) to be audited at a deep level by leveraging deep data inspection techniques such as content analytics, sentiment analytics, contextual views based on natural language classification as well as APIs such as speech to text transformation, visual recognition, etc. These techniques help in capturing metadata information about the data on the storage subsystem. Specifically, metadata is scanned from a storage subsystem to understand which stored files/objects contain sensitive or critical information based on one or more predetermined policies.

These policies trigger deep data inspection leveraging various techniques that extract facets from the candidate (file/object) data, and the facets are indexed. The system then can query the index to identify the candidate (sensitive/critical) documents based on the facets, and calculate the sensitivity/criticality level to define a protection level.

Also, a job procuring cognitive insights of certain data may be initiated based on live events, which can help identify the data to be audited in order to find anomalies and make data more secure on a storage subsystem, in near real time in a highly scalable and high-performance fashion.

This enables previously unattainable levels of auditing and data insight for data security. Other techniques such as header extraction may also be used to derive insight about the content of the candidate data for encryption.

After obtaining the categorization of data by compliance level or sensitivity levels, system level operation auditing may then be assigned. Based on the data classification, an appropriate audit logging level may be assigned to data, as per one or more policies, across various storage sub-systems. This results in improved auditing for sensitive data to find potential anomalies in a heterogenous data storage environment.

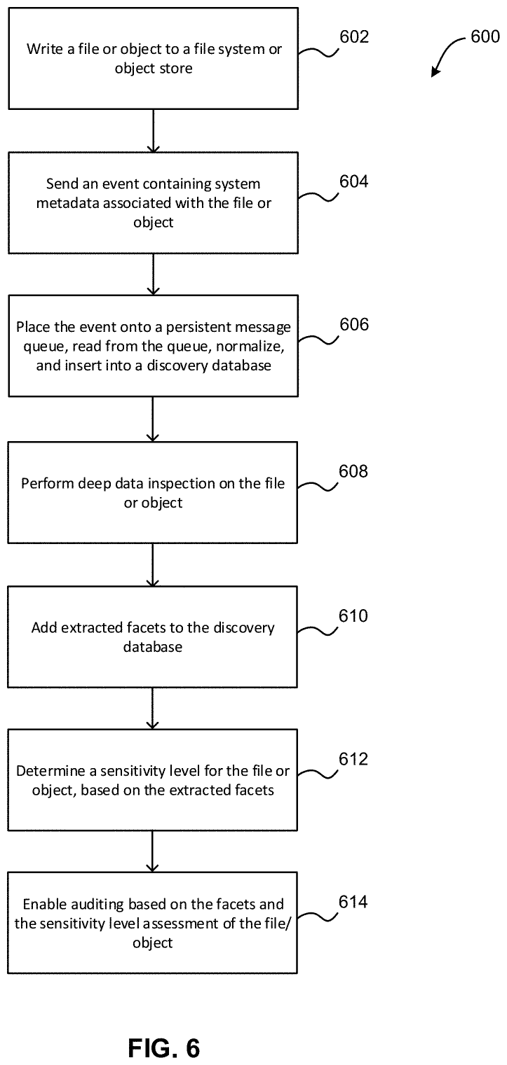

Now referring to FIG. 6, a flowchart of a method 600 for performing event-driven data auditing classification via database query is shown according to one embodiment. The method 600 may be performed in accordance with the present invention in any of the environments depicted in FIGS. 1-4, among others, in various embodiments. Of course, more or less operations than those specifically described in FIG. 6 may be included in method 600, as would be understood by one of skill in the art upon reading the present descriptions.

Each of the steps of the method 600 may be performed by any suitable component of the operating environment. For example, in various embodiments, the method 600 may be partially or entirely performed by one or more servers, computers, or some other device having one or more processors therein. The processor, e.g., processing circuit(s), chip(s), and/or module(s) implemented in hardware and/or software, and preferably having at least one hardware component may be utilized in any device to perform one or more steps of the method 600. Illustrative processors include, but are not limited to, a central processing unit (CPU), an application specific integrated circuit (ASIC), a field programmable gate array (FPGA), etc., combinations thereof, or any other suitable computing device known in the art.

As shown in FIG. 6, method 600 may initiate with operation 602, where a file or object is written by an application or user to a file system or object store. Additionally, method 600 may proceed with operation 604, where a storage system sends an event containing system metadata associated with the file or object.

Further, method 600 may proceed with operation 606, where the event is placed onto a persistent message queue and is read from the queue, normalized, and inserted them into a discovery database. Further still, method 600 may proceed with operation 608, where deep data inspection is performed on the file or object. Additionally, method 600 may proceed with operation 610, where extracted facets are added to the discovery database.

Also, method 600 may proceed with operation 612, where a sensitivity level is determined for the file or object, based on the extracted facets. For example, the facets may indicate that file has a SSN in it, has an email backup, is a movie file, etc. Further, method 600 may proceed with operation 614, where, auditing is enabled based on the facets and the sensitivity level assessment of the file/object.

In an alternate embodiment, a storage system may register an event consumer in the discovery database and may directly receive events from storage pertaining to which files have been modified as well as what is in the files via deep data inspection, to eliminate discovery database queries and to trigger an instantaneous data protection mechanism for better resiliency.

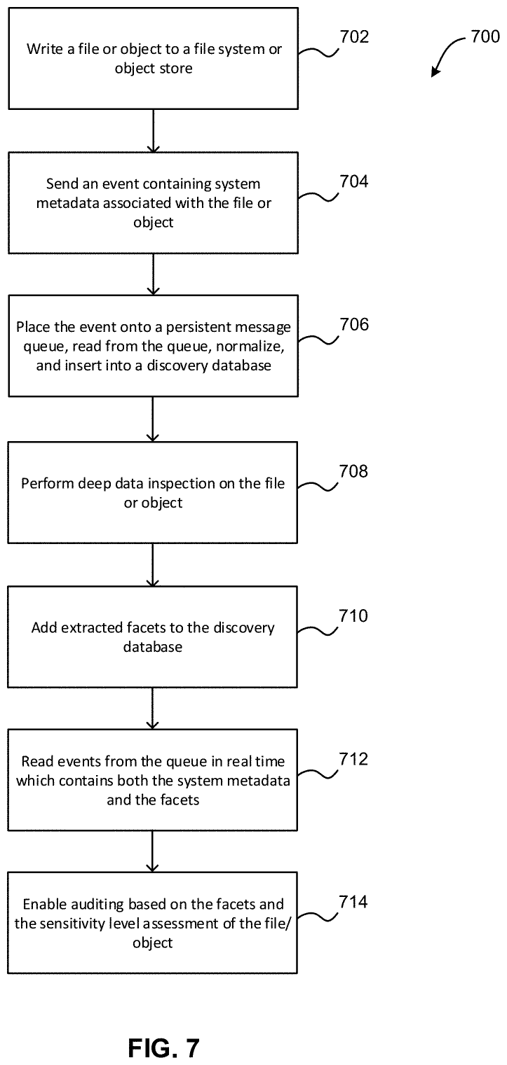

Now referring to FIG. 7, a flowchart of a method 700 for performing event-driven data auditing classification via event consumer is shown according to one embodiment. The method 700 may be performed in accordance with the present invention in any of the environments depicted in FIGS. 1-4, among others, in various embodiments. Of course, more or less operations than those specifically described in FIG. 7 may be included in method 700, as would be understood by one of skill in the art upon reading the present descriptions.

Each of the steps of the method 700 may be performed by any suitable component of the operating environment. For example, in various embodiments, the method 700 may be partially or entirely performed by one or more servers, computers, or some other device having one or more processors therein. The processor, e.g., processing circuit(s), chip(s), and/or module(s) implemented in hardware and/or software, and preferably having at least one hardware component may be utilized in any device to perform one or more steps of the method 700. Illustrative processors include, but are not limited to, a central processing unit (CPU), an application specific integrated circuit (ASIC), a field programmable gate array (FPGA), etc., combinations thereof, or any other suitable computing device known in the art.

As shown in FIG. 7, method 700 may initiate with operation 702, where a file or object is written by an application or user to a file system or object store. Additionally, method 700 may proceed with operation 704, where a storage system sends an event containing system metadata associated with the file or object.

Further, method 700 may proceed with operation 706, where the event is placed onto a persistent message queue and is read from the queue, normalized, and inserted them into a discovery database. Further still, method 700 may proceed with operation 708, where deep data inspection is performed on the file or object. Additionally, method 700 may proceed with operation 710, where extracted facets are added to the discovery database.

Further, method 700 may proceed with operation 712, where an event consumer reads events from the queue in real time which contains both the system metadata and the facets. Also, method 700 may proceed with operation 714, where auditing is enabled based on the facets and the sensitivity level assessment of the file/object.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Moreover, a system according to various embodiments may include a processor and logic integrated with and/or executable by the processor, the logic being configured to perform one or more of the process steps recited herein. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
analyzing data to determine a sensitivity level for the data;
assigning an audit level to the data, based on the sensitivity level; and
performing auditing for the data, based on the audit level.

2. The computer-implemented method of claim 1, wherein the data is identified in response to parsing stored data within a database.

3. The computer-implemented method of claim 1, wherein the data is identified in response to receiving the data as an upload from a user or application.

4. The computer-implemented method of claim 1, wherein analyzing the data includes performing deep data inspection on the data.

5. The computer-implemented method of claim 1, wherein analyzing the data includes determining metadata associated with the data, the metadata describing an owner of the data, a date and time of a creation of the data, and a location of a creation of the data.

6. The computer-implemented method of claim 1, wherein metadata is determined for the data by inspecting the data utilizing content analytics, sentiment analytics, natural language classification, speech to text transformation, and visual recognition.

7. The computer-implemented method of claim 1, wherein analyzing the data may include determining a sensitivity level for the data, based on a comparison of metadata for the data to one or more predetermined policies.

8. The computer-implemented method of claim 1, wherein the data is assigned a predetermined sensitivity level in response to determining that metadata for the data indicates that one or more predetermined types of information is contained within the data.

9. The computer-implemented method of claim 1, wherein the audit level is assigned to the data by applying the sensitivity level to one or more predetermined policies.

10. The computer-implemented method of claim 1, wherein the audit level indicates one or more types of auditing to be performed for the data, one or more locations where the auditing is performed, one or more entities to perform the auditing, and one or more locations where auditing data is to be stored.

11. The computer-implemented method of claim 1, wherein performing the auditing for the data includes monitoring access to the data within a system.

12. The computer-implemented method of claim 1, wherein performing the auditing for the data includes recording results of monitoring access to the data.

13. The computer-implemented method of claim 1, wherein the audit level indicates one or more locations within a system where the auditing is to be performed for the data.

14. The computer-implemented method of claim 1, further comprising:
performing a second analysis on the data after the audit level has been assigned to the data;
determining a second sensitivity level for the data, based on the second analysis;
assigning a second audit level to the data, based on the second sensitivity level; and
adjusting the auditing for the data, based on the second audit level.

15. A computer program product for determining an audit level for data, the computer program product comprising a computer readable storage medium having program instructions embodied therewith, wherein the computer readable storage medium is not a transitory signal per se, the program instructions executable by a processor to cause the processor to perform a method comprising:
analyzing, by the processor, data to determine a sensitivity level for the data;
assigning, by the processor, an audit level to the data, based on the sensitivity level; and
performing, by the processor, auditing for the data, based on the audit level.

16. The computer program product of claim 15, wherein the data is identified in response to parsing stored data within a database.

17. The computer program product of claim 15, wherein the data is identified in response to receiving the data as an upload from a user or application.

18. The computer program product of claim 15, wherein analyzing the data includes performing deep data inspection on the data.

19. The computer program product of claim 15, wherein analyzing the data includes determining metadata associated with the data, the metadata describing an owner of the data, a date and time of a creation of the data, and a location of a creation of the data.

20. A system, comprising:
a processor; and
logic integrated with the processor, executable by the processor, or integrated with and executable by the processor, the logic being configured to:
analyze data to determine a sensitivity level for the data;
assign an audit level to the data, based on the sensitivity level; and
perform auditing for the data, based on the audit level.
